(19) United States
(12) Patent Application Publication
(10) Pub. No.: US 2007/0181272 A1
(43) Pub. Date: Aug. 9, 2007

(54) Insta window

(76) Inventor: Crystal Lewis, Hesperia, CA (US)

Correspondence Address: CRYSTAL LEWIS, P.O. Box 2276, VICTORVILLE, CA, 92395, US

(21) Appl. No.: 11/485,731

(22) Filed: Oct. 17, 2006

Related U.S. Application Data
(60) Provisional application No. 60/765,972, filed on Feb. 7, 2006.

(51) Int. Cl. E06B 9/00

(52) U.S. Cl. 160/368.1

(57) ABSTRACT

A transparent temporary replacement window that can be conveniently and easily attached to cover the opening that is left when there is a broken window. The material consists of clear Acetate film that can be cut to size to fit over the opening of a broken vehicle window. Either a side window or rear window can be covered by the temporary window. Magnetic tape will be used to attach the film to the frame.

the present Invention relates to a temporary window that can be used to cover the opening left when there is a missing window. To be specific, a sheet of flexible film will be cut to size then attached to the frame by magnetic tape. The magnetic tape will allow easy removal, with no damage to the vehicle's paint. The original idea derived from my experience with a broken rear window. I had no means to purchase another glass window at the time, so I covered the opening with cardboard. I have seen many other individuals resort to various methods, such as, being exposed to the elements. The film that is used to cover the opening needs to be transparent for the desired visibility during driving otherwise their driving will be impaired. If the film does not fit properly, either loose or incorrect thickness, there could be an additional risk to the driver. The Insta-Window can be cut to size and will fit properly and secure, due to the use of magnetic tape. Because of the formally mentioned problems that could occur, the need for an inexpensive yet functionally sound temporary window system should be made available. The present invention meets the need to provide a temporary window.

### BRIEF DESCRIPTION OF THE SEVERAL VIEWS OF THE DRAWINGS

The invention for which I will provide a detailed description will be more understood by reference to the explanation hereto when read in conjunction with the attached drawings, and wherein:

FIG. 1a, 1b are perspective views of the vehicle's side-door with a sample of the installed, and with sample of cut to size

FIG. 2a, 2b are perspective views of the vehicle's rear window with a sample of the installed

FIG. 3a, 3b shows the shaded image of the ½ inch wide magnetic tape that connects the film to the outer frame of the vehicle, in order to hold the film in place, without causing permanent damage to the vehicle's paint

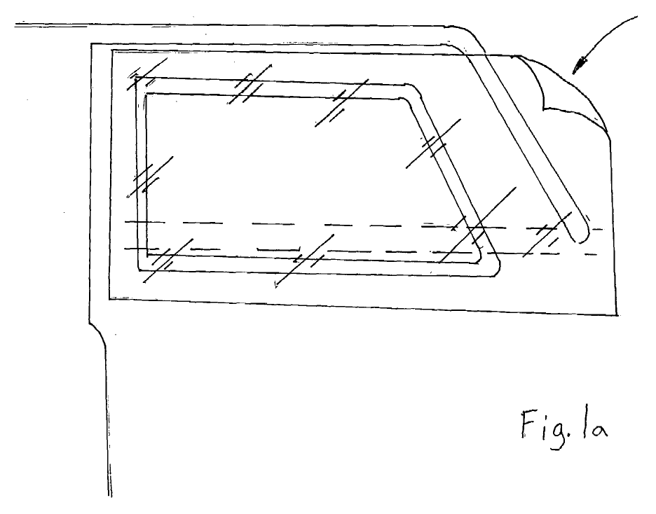

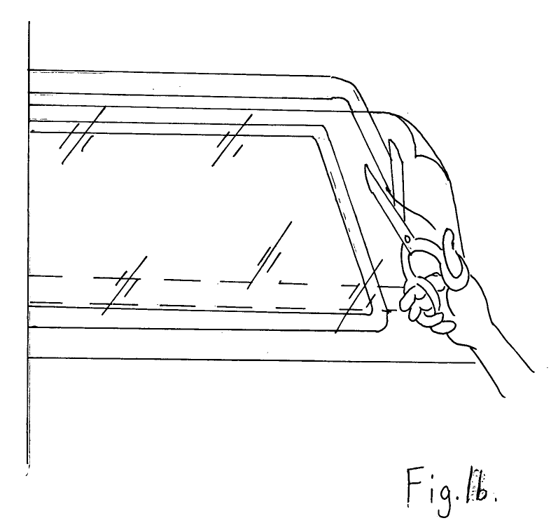

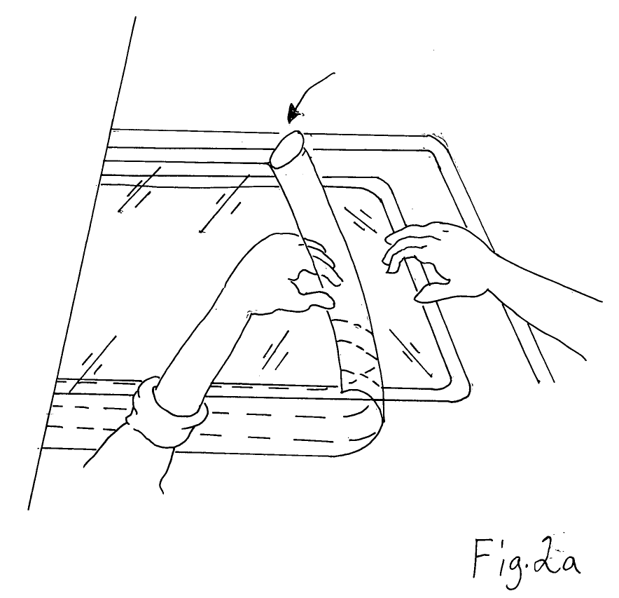

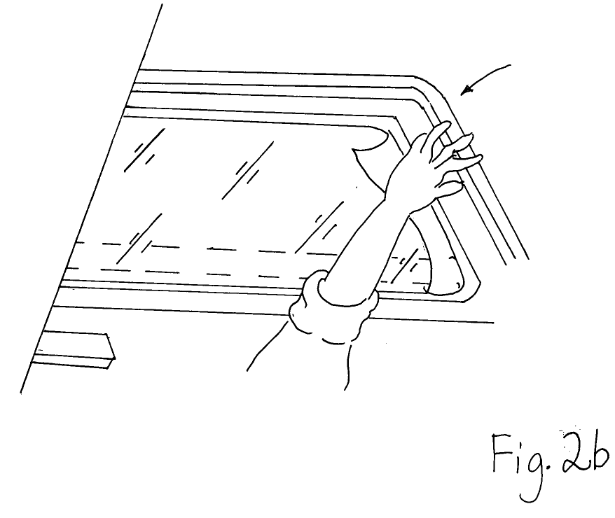

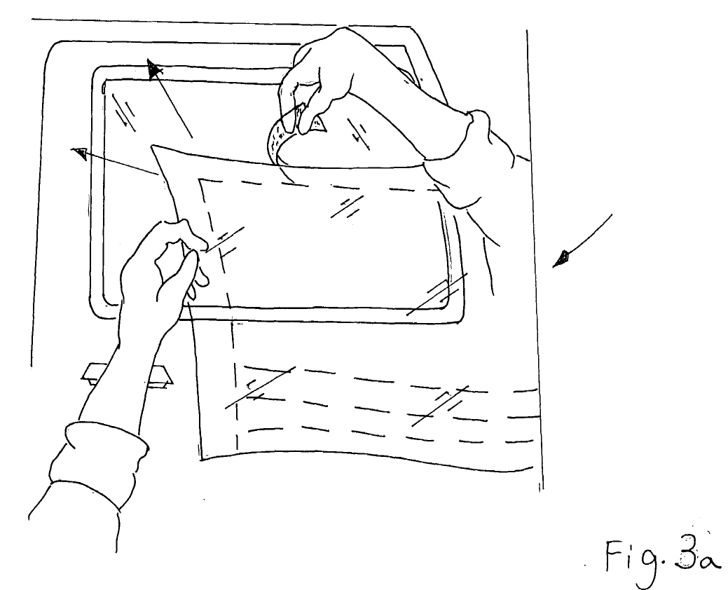

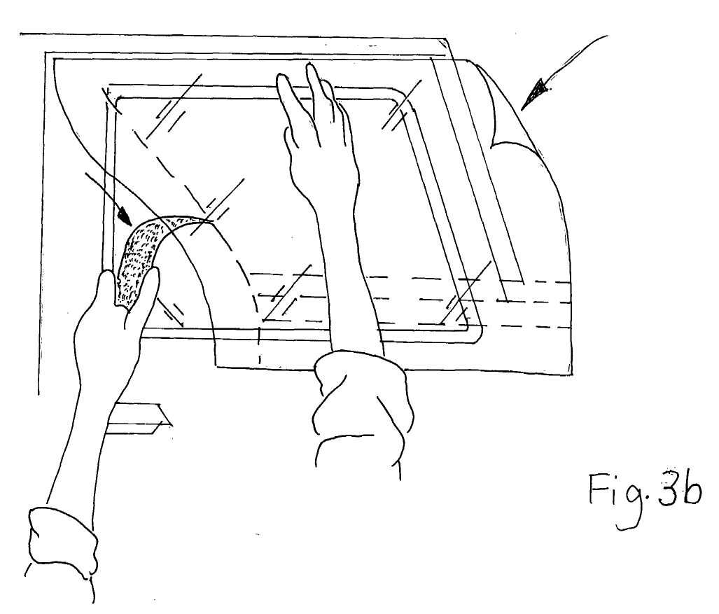

### DETAILED DESCRIPTION OF THE INVENTION

In reference to the drawings in more detail, showing the practicality and convenience of using the temporary Insta-Window. The window is made of durable and flexible Acetate film. The covering for the window is designed, cut and shaped to fit firmly onto the frame of the sides and rear of the vehicle. The plastic is thin and flexible enough for easy application. It is created solely for temporary relief against the elements: rain, wind, cold, etc. A standard automobile glass is four times greater in weight than the Insta-Window covering—making my invention a practical ideal substitute for handling heavy glass that is more difficult to install. The standard car door window and rear window's shape and size and dimensions will be easy for the Insta-Window to accommodate.

Standard automobile side door front window is approximately sixteen to eighteen inches in height. The plastic is cut to size so that there will be no need for exact measurements of plastic. The ultimate idea was to make a product that would be easy to handle, without the hassle of messy glues and tape that could leave permanent damage to a vehicle's paint job. The Insta-Window can be reused. It can be folded or rolled up to be stored away for later use.

The Acetate film is not pre-cut with a particular pattern; it is basically a sheet of plastic you cut to size, one-size-fits-all. After measuring the film to the opening of the vehicle, the magnetic tape can then be applied to the film, and then the film can be attached to the vehicle's frame. After the film is attached, the film that extends past the tape can be trimmed away, leaving a practical temporary window.

What I claim my invention is:

1. A replacement window made of flexible and durable plastic, created to substitute a glass window for use on the side doors as well as the rear window for temporary use. It's easy use and application allows anyone to be able to replace a broken window. It has clear plastic which provides visual clarity to insure safety. Simplicity and affordability is the main goal of my idea. The Insta-Window was created to provide temporary covering to protect the vehicle and it's passengers from the elements.

2. The removable plastic cover set fourth in claim 1, whereby said has flexibility and durability, which makes for easy handling and secure fitting.

3. The removable plastic cover set fourth in claim 1, whereby said has clear plastic that provides good visibility, decreasing obstacles and increasing safe driving practices.

4. The removable plastic cover set fourth in claim 1, whereby said has magnetic tape attached which allows for easy application as well as easy removal, with no mess or damage to the vehicle's paint. My invention will provide the least complicated and economical solution to the common problem of a broken window.
